(19) United States
(12) Patent Application Publication
(10) Pub. No.: US 2023/0238699 A1
(43) Pub. Date: Jul. 27, 2023

(54) ANTENNA DEVICE WITH COLLABORATIVE RADIATORS FOR PARAMETER CONTROL

(71) Applicant: HUAWEI TECHNOLOGIES CO., LTD., Shenzhen (CN)

(72) Inventors: Alejandro MURILLO BARRERA, Munich (DE); Juan SEGADOR ALVAREZ, Munich (DE); Francesco CAMINITA, Munich (DE); Cristian DELLA GIOVAMPAOLA, Munich (DE); Stefano MACI, Munich (DE); Enrica MARTINI, Munich (DE); Bruno BISCONTINI, Munich (DE); Ignacio GONZALEZ, Munich (DE)

(21) Appl. No.: 18/296,079

(22) Filed: Apr. 5, 2023

Related U.S. Application Data
(63) Continuation of application No. PCT/EP2020/078070, filed on Oct. 7, 2020.

(51) Int. Cl. H01Q 3/40; H01P 5/18; H01P 1/18; H01P 1/22

(52) U.S. Cl. CPC H01Q 3/40; H01P 5/18; H01P 1/18; H01P 1/22

(57) ABSTRACT

The present disclosure relates to antenna devices and arrays of antenna devices. One example antenna device includes a first radiator configured to radiate a first electromagnetic signal, a second radiator configured to radiate a second electromagnetic signal, and a joint feeding network including a first 180-degree coupler and a second 180-degree coupler arranged in sequence. The first 180-degree coupler receives first input signal and second input signal, and the second 180-degree coupler provides first output signal to the first radiator and second output signal to the second radiator. In the joint feeding network, a first path connects the first 180-degree coupler to the second 180-degree coupler including a first phase shifter. A second path connects the first 180-degree coupler to the second 180-degree coupler including a second phase shifter and an attenuator.

### CROSS-REFERENCE TO RELATED APPLICATIONS

This application is a continuation of International Application No. PCT/EP2020/078070, filed on Oct. 7, 2020, the disclosure of which is hereby incorporated by reference in its entirety.

### TECHNICAL FIELD

The present disclosure relates generally to the field of antennas; and more specifically, to antenna devices and an array of antenna devices.

### BACKGROUND

With the deployment of new wireless communication technologies, such as fifth generation (5G) communication technology, there is a growing demand to develop antennas for reliable communication. Despite an increase in a number of required frequency bands as well as an increase in the number of users (i.e. terrestrial mobile users), there is a limitation associated with a number of antennas which can be deployed. Generally, a significant increase in the size (i.e. dimensions) of the conventional antenna is also not preferred or allowed. Thus, in such scenarios, it becomes technically challenging to design and develop an adequate antenna structure without increasing complexity.

Currently, in base station antenna systems, there are low frequency antenna arrays that have radiators (i.e. radiating elements) which are tightly-spaced (i.e. in close proximity to each other). Due to the proximity of the radiators, there is a degradation in the performance of a conventional antenna array in terms of directivity (i.e. concentration of radiation from antenna array in a particular direction) and beam squint (i.e. an angle that a radiation is offset from the normal of the plane of the antenna array). In an example, in such conventional low frequency antenna arrays, there is a loss of directivity and further the radiations are squinted. Furthermore, a suitable level of isolation between radiators belonging to different antenna arrays needs to be maintained, which is again a challenging task.

Some conventional techniques marginally improve performance of an antenna array by introducing arbitrary phase-difference couplers along with the radiators of the antenna array. However, such techniques lead to an asymmetric radiation output. In an example, output from a first port of the coupler has a phase difference of 60 degrees while the output from a second port of the coupler has a phase difference of 120 degrees. Other conventional techniques used for decoupling the tightly-spaced radiators include using superstrates and reflectors. However, such conventional techniques are not able to maintain desired levels of directivity and beam squint for the tightly spaced radiators in the conventional antenna arrays. Moreover, some conventional techniques in which there is somewhat reduced beam squint and increased directivity, the tightly-spaced radiators do not work simultaneously. Thus, it is still a technical problem of how to obtain desired performance levels of the antenna arrays having tightly spaced radiators.

Therefore, in light of the foregoing discussion, there exists a need to overcome the aforementioned drawbacks associated with conventional antenna devices.

### SUMMARY

The present disclosure seeks to provide an antenna device and an array of antenna devices. The present disclosure seeks to provide a solution to the existing problem of degradation in system performance (e.g. increased beam squint and decreased directivity) of antenna devices having radiators in close proximity. An aim of the present disclosure is to provide a solution that overcomes at least partially the problems encountered in prior art, and provide an improved structure of antenna devices to significantly improve the system performances of antenna device having radiators in close proximity by introduction of attenuation (i.e. losses) in a network of antenna devices.

The object of the present disclosure is achieved by the solutions provided in the enclosed independent claims. Advantageous implementations of the present disclosure are further defined in the dependent claims.

In one aspect, the present disclosure provides an antenna device comprising: a first radiator configured to radiate a first electromagnetic signal; a second radiator configured to radiate a second electromagnetic signal; and a joint feeding network comprising a first 180-degree coupler and a second 180-degree coupler arranged in sequence; wherein the first 180-degree coupler is configured to receive a first input signal through a first input port and a second input signal through a second input port; wherein the second 180-degree coupler is configured to provide a first output signal to the first radiator and a second output signal to the second radiator; wherein a first path connecting the first 180-degree coupler to the second 180-degree coupler comprises a first phase shifter; and wherein a second path connecting the first 180-degree coupler to the second 180-degree coupler comprises a second phase shifter and an attenuator.

The antenna device of the present disclosure has significantly improved system performance in comparison to conventional antenna devices. The antenna devices of the present disclosure take advantage of tightly spaced first and second radiators such that the two radiators cooperate to radiate together. The two radiators are jointly fed by the joint feeding network in comparison to conventional antenna devices where radiators are independently fed. As a result of which, the antenna device of the present disclosure has higher directivity compared to conventional antenna devices. The attenuator introduces losses to control coupling coefficient. Moreover, the phase shifter enables in controlling a squint in radiating patterns of the antenna device. Furthermore, the 180-degree couplers enable in obtaining enhanced isolation between input ports. As a result, the antenna device of the present disclosure has significantly increased directivity and reduced squint in comparison to conventional antenna devices.

In an implementation form, a set of parameters comprising a first phase shift of the first phase shifter, a second phase shift of the second phase shifter and an attenuation of the attenuator is determined based on one or more desired features of radiating patterns of the first electromagnetic signal and the second electromagnetic signal.

By virtue of the first phase shifter, the second phase shifter and the attenuator, the value of attenuation and the phase-shifts are adjusted which allows to find a balance between squint and efficiency of radiating patterns. Different values of attenuation enable control of coupling coefficients. Selection of different value of the phase shifts allows control on the squint between radiating patterns.

In a further implementation form, the one or more features of the radiating patterns include a squint of the radiating patterns.

By virtue of phase shifters, the antenna device of the present disclosure obtains reduced squint of radiating patterns in comparison to conventional antenna devices which have close side-by-side radiators used cooperatively.

In a further implementation form, the one or more features of the radiating patterns include a directivity of the radiating patterns.

By virtue of combining feed of the two radiators via the joint feeding network, the antenna device of the present disclosure obtains higher directivity of the radiating patterns in comparison to conventional antenna devices.

In a further implementation form, the one or more features of the radiating patterns include a coupling between the radiating patterns measured at the first and second input ports.

By virtue of the first and the second input ports the feed of the two radiators is controlled which enables in controlling the coupling between radiating patterns of the two radiators.

In a further implementation form, the joint feeding network is configured such that the first electromagnetic signal and the second electromagnetic signal combine to form a first radiating pattern corresponding to the first input signal and a second radiating pattern corresponding to the second input signal.

Feeding the joint feeding network from one of the input ports potentially produces the first radiation pattern with the contribution of both the first radiator and the second radiator. In other words, the first input signal through the first input port is intended to produce the first radiation pattern, which is obtained by the joint radiation of the first radiator and the second radiator. Further, feeding the joint feeding network from the other input port potentially produces the second radiation pattern with the contribution of both the first radiator and the second radiator, where the two radiation patterns are independent from each other.

In a further implementation form, the first radiator and the second radiator are configured to operate in a frequency band.

By virtue of the joint feeding network, the first radiator and the second radiator are jointly feed to operate in the frequency band, in comparison to conventional antenna devices wherein the radiators are independently fed.

In a further implementation form, the frequency band corresponds to a wavelength, and wherein a distance between the first radiator and the second radiator is less than the wavelength.

By virtue of the distance of less than wavelength, the two radiators are tightly-spaced to enable providing radiation to a required number of users without compromising on system performance, such as directivity and beam squint.

In another aspect, the present disclosure provides an array of antenna devices, comprising two or more of the antenna devices.

The array of antenna device of the present disclosure has significantly improved system performance in comparison to conventional array of antenna devices. The array of antenna devices of the present disclosure takes advantage of tightly spaced radiators such that the two radiators cooperate to radiate together. As a result, the array of antenna device of the present disclosure has significantly increased directivity and reduced beam squint in comparison to conventional array of antenna devices.

In an implementation form, the first phase shifter, the second phase shifter and the attenuator of each antenna device are configured based on a collective radiating pattern and a collective attenuation loss of the array.

By virtue of the first phase shifter and the second phase shifter squint of the collective radiating pattern is controlled and a coupling coefficient between the first radiator and the second radiator is controlled by the attenuator.

In a further implementation form, a first power combiner arranged to provide the first input signal to each of the first input ports, and a second power combiner arranged to provide the second input signal to each of the second input ports.

By virtue of the first power combiner and the second power combiner, the array of the present disclosure provides feeds for one respective independent radiation pattern via the first input port and the second input port.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is an illustration of an antenna device with a joint feeding network, in accordance with an embodiment of the present disclosure;

FIG. 1B is a perspective view of an antenna device with a joint feeding network, in accordance with another embodiment of the present disclosure;

FIG. 2A is an illustration of an array of antenna devices, in accordance with an embodiment of the present disclosure;

FIG. 2B is an illustration of an array of antenna devices, in accordance with another embodiment of the present disclosure;

FIG. 3 is a graphical representation that depicts a network efficiency of an antenna device, in accordance with an embodiment of the present disclosure;

FIG. 4 is a graphical representation that depicts a radiation pattern of an antenna device, in accordance with an embodiment of the present disclosure;

FIG. 5 is a graphical representation that depicts a radiation pattern in a main plane of an antenna device operation, in accordance with an embodiment of the present disclosure; and

FIG. 6 is an illustration of an array of antenna devices in comparison to a conventional array of antenna devices, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

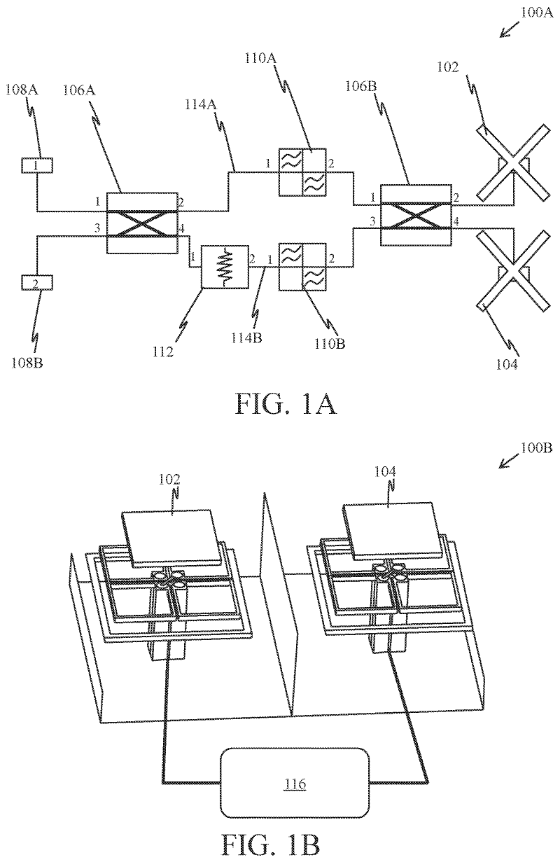

FIG. 1A is an illustration of an antenna device with a joint feeding network, in accordance with an embodiment of the present disclosure. With reference to FIG. 1, there is shown the antenna device 100A. The antenna device 100A includes a first radiator 102 and a second radiator 104. The antenna device 100A further includes a joint feeding network that includes a first 180-degree coupler 106A and a second 180-degree coupler 106B. There is further shown a first input port 108A, a second input port 108B, a first phase shifter 110A, a second phase shifter 110B and an attenuator 112.

In one aspect, the present disclosure provides an antenna device 100A comprising:
a first radiator 102 configured to radiate a first electromagnetic signal;
a second radiator 104 configured to radiate a second electromagnetic signal; and
a joint feeding network comprising a first 180-degree coupler 106A and a second 180-degree coupler 106B arranged in sequence;
wherein the first 180-degree coupler 106A is configured to receive a first input signal through a first input port 108A and a second input signal through a second input port 108B;
wherein the second 180-degree coupler 106B is configured to provide a first output signal to the first radiator 102 and a second output signal to the second radiator 104;
wherein a first path connecting the first 180-degree coupler 106A to the second 180-degree coupler 106B comprises a first phase shifter 110A; and
wherein a second path connecting the first 180-degree coupler 106A to the second 180-degree coupler 106B comprises a second phase shifter 110B and an attenuator 112.

The antenna device 100A may also be referred to as a radiating device. The antenna device 100A is used for telecommunication. For example, the antenna device 100A may be used in a wireless communication system. In some embodiments, an array of such antenna devices or one or more antenna devices, may be used in the communication system. Examples of such wireless communication system include, but is not limited to, a base station (such as an Evolved Node B (eNB), a gNB, and the like), a repeater device, a customer premise equipment, and other customized telecommunication hardware.

The antenna device 100A includes the first radiator 102 configured to radiate a first electromagnetic signal. In an example, the first radiator 102 is configured to radiate the first electromagnetic signal in a defined direction, for example, via aperture of the first radiator 102. For example, the first electromagnetic signals radiated by the first radiator 102 may be a downlink or an uplink communication. In an implementation, the first radiator 102 is further configured to receive an electromagnetic signal, for example, from user equipment (UEs).

The antenna device 100A includes the second radiator 104 configured to radiate a second electromagnetic signal. In an example, the second radiator 104 is configured to radiate the second electromagnetic signal in a defined direction, for example, via aperture of the second radiator 104 which may be different from the aperture of the first radiator 102. Alternatively, in an example, the second radiator 104 is further configured to receive an electromagnetic signal.

According to an embodiment, the first radiator 102 and the second radiator 104 are configured to operate in a frequency band. In an example, the frequency band may be a fifth generation (5G) frequency band, for example, 5G New Radio (NR) frequency band (e.g. F1 band or F2 band). For example, the frequency band is a sub-6 GHz frequency band, such as 450 Megahertz to 6 Gigahertz (e.g. F2 band). The first radiator 102 and the second radiator 104 may radiate electromagnetic signals of same frequency in the frequency band. Although, in some implementations, the first radiator 102 and the second radiator 104 may be configured to radiate electromagnetic signals of different frequencies.

According to an embodiment, the frequency band corresponds to a wavelength, and wherein a distance between the first radiator 102 and the second radiator 104 is less than the wavelength. As a result, the first radiator 102 and the second radiator 104 are tightly-spaced (i.e. in close proximity) in the antenna device 100A. In comparison to conventional antenna devices where tightly-spaced radiators reduce system performance of the conventional antenna devices, the antenna device 100A of the present disclosure overcomes the problems due to tightly-spaced radiators, by using the joint feeding network, and thereby has improved system performances.

The antenna device 100A includes the joint feeding network comprising the first 180-degree coupler 106A and the second 180-degree coupler 106B arranged in sequence. The joint feeding network herein refers to electrically conductive tracks with one or more electronic components that are configured to provide feed to both the first radiator 102 and the second radiator 104. The joint feeding network enables the antenna device 100A of the present disclosure to have improved system performance, such as improved directivity and controlled beam squint of the electromagnetic radiation transmitted by the radiators. Moreover, the joint feeding network is symmetric for both the first 180-degree coupler 106A and the second 180-degree coupler 106B. As a result, both the first radiator 102 and the second radiator 104 can be used simultaneously and operate jointly, i.e. in cooperation with each other in comparison to some conventional antenna devices where the radiators cannot be used simultaneously, or when used simultaneously work independently with each other having comparatively very low system performance and coupling issues.

Beneficially, combining the two radiators (i.e. the first radiator 102 and the second radiator 104) via the joint feeding network implies taking advantage of a larger aperture (i.e. larger radiating area) in comparison to conventional antenna devices and thereby increased directivity is obtained by the antenna device 100A of the present disclosure. In conventional antenna devices such radiators which are in close proximity are independently connected to respective feeding networks (i.e. the two radiators are independently fed) as a result the aperture of conventional antenna devices is substantially lower than the aperture of the antenna device 100A of the present disclosure. Moreover, the conventional antenna devices have lower levels of directivity, strong inter-element coupling in comparison to antenna device 100A of the present disclosure.

Each of the first 180-degree coupler 106A and the second 180-degree coupler 106B is a four port device that is configured to receive two input signals (or feeds) via the two ports and provide two output signals (feeds), which are 180-degree phase shifted via the other two ports. The first 180-degree coupler 106A and the second 180-degree coupler 106B are arranged in sequence in a way that the second 180-degree coupler 106B is closer to the first radiator 102 and the second radiator 104 in comparison to the first 180-degree coupler 106A, as shown in an example.

The joint feeding network comprising the first 180-degree coupler 106A is configured to receive a first input signal through a first input port 108A and a second input signal through a second input port 108B. Each of the first input port 108A and the second input port 108B is configured to provide input signals (i.e. feed) for the first radiator 102 and the second radiator 104. In an example, an amplitude and frequency of feed provided by the first input port 108A and the second input port 108B is based on a frequency of the electromagnetic signal to be transmitted by the first radiator 102 and the second radiator 104. Based on the first input signal and the second input signal received by the first 180-degree coupler 106A, two output signals are generated. In an example, the two output signals are 180-degree phase apart.

The output signal provided by the first 180-degree coupler 106A is represented by function (1) that is shown below.

$${S}_{1} = ( \begin{matrix}0 & {α}_{1} & 0 & {β}_{1} \\ {α}_{1} & 0 & {β}_{1} & 0 \\ 0 & {β}_{1} & 0 & - {α}_{1} \\ {β}_{1} & 0 & - {α}_{1} & 0\end{matrix} ) \qquad ( 1 )$$

wherein
in a case where an input signal with a unit amplitude enters at port ‘1’ of the first 180-degree coupler 106A, the signal is distributed into α₁ signal (i.e. α₁ amplitude at port ‘2’ of the first 180-degree coupler 106A) and β₁ signal (i.e. β₁ amplitude at port ‘4’ of the first 180-degree coupler 106A) (e.g. as observed in column 1 in the matrix of function (1), α₁ occupies row 2 and β₁ occupies row 4, in this case)
where,
α₁ is an amplitude of a signal represented by a real number within 0 to 1 (i.e. has a value greater than zero and less than or equal to one), β₁ refers to an amplitude of a signal represented by a real number between 0 and 1 (i.e. has a value greater than zero and less than or equal to one, wherein the fact that α₁ and β₁ are both real numbers within 0 and 1, implies that both output signals will have the same phase (i.e. the same time delay). Moreover, when an input signal with a unit amplitude enters at port ‘3’ (e.g. as observed in column 3 of matrix in above function (1)) of the first 180-degree coupler 106A, one of the output is negative (i.e. −α₁ in column 3 of the matrix), which implies that one output signal, i.e. −α₁, is out of phase with respect to other output signal that is β₁. S₁ refers to the output signal produced by the first 180-degree coupler 106A.

The joint feeding network comprising the second 180-degree coupler 106B is configured to provide a first output signal to the first radiator 102 and a second output signal to the second radiator 104. The second 180-degree coupler 106B is configured to receive as input, the two output signals provided by the first 180-degree coupler 106A. Further based on the provided output signals by the first 180-degree coupler 106A, the second 180-degree coupler 106B provides the first output signal and the second output signal. Beneficially, the presence of the first 180-degree coupler 106A and the second 180-degree coupler 106B enables in providing improved isolation between the first input port 108A and the second input port 108B. Specifically, the present disclosure provides significantly improved port-to-port isolation by the use of first 180-degree coupler 106A and the second 180-degree coupler 106B.

The first output signal and the second output signal provided by the second 180-degree coupler 106B is represented by function (2) that is shown below.

$${S}_{2} = ( \begin{matrix}0 & {α}_{2} & 0 & {β}_{2} \\ {α}_{2} & 0 & {β}_{2} & 0 \\ 0 & {β}_{2} & 0 & - {α}_{2} \\ {β}_{2} & 0 & - {α}_{2} & 0\end{matrix} ) \qquad ( 2 )$$

wherein
when a signal is received at port ‘1’ of the second 180-degree coupler 106B, the signal is distributed into α₂ signal and β₂ signal,
α₂ is an amplitude of a signal received by a port ‘2’ of the second 180-degree coupler 106B,
β₂ refers to an amplitude of a signal received by a port ‘4’ of the second 180-degree coupler 106B,
wherein α₂ and β₂ have same phase (i.e. same time delay)
when a signal is received at port ‘3’ of the second 180-degree coupler 106B, the signal is distributed into −α₂ signal and β₂ signal,
−α₂ refers to the amplitude of a signal received by the port ‘2’ of the second 180-degree coupler 106B, wherein −α₂ is out of phase with respect to β₂, wherein α₂ and B₂ have values greater than zero and less than or equal to one, S₂ refers to the first and the second output signal produced by the second 180-degree coupler 106B.

According to an embodiment, the joint feeding network is configured such that the first electromagnetic signal and the second electromagnetic signal combine to form a first radiating pattern corresponding to the first input signal and a second radiating pattern corresponding to the second input signal. Beneficially, feeding the joint feeding network from one of the input ports (for example the first input port 108A) potentially produces the first radiation pattern with the contribution of both the first radiator 102 and the second radiator 104. Further, accessing the joint feeding network from the other input port (for example the second input port 108B) potentially produces the second radiation pattern with the contribution of both the first radiator 102 and the second radiator 104. Moreover, the two aforementioned radiation patterns are independent from each other.

A first path 114A connecting the first 180-degree coupler 106A to the second 180-degree coupler 106B comprises a first phase shifter 110A. The first phase shifter 110A is configured to apply controllable phase shift to output signal provided by the first 180-degree coupler 106A to the second 180-degree coupler 106B via the first path 114A. In an example, the first phase shifter 110A receives, as input, the output signal from the first 180-degree coupler 106A and provides controlled phase shifted output signal to the second 180-degree coupler 106B. The first path 114A herein refers to electrically conductive tracks, for example, metallic tracks, via which signal is provided from the first 180-degree coupler 106A to the second 180-degree coupler 106B.

The controlled phase shifted output signal provided by the first phase shifter 110A to the second 180-degree coupler 106B is represented by function (3) that is shown below.

$${S}_{3} = ( \begin{matrix}0 & {e}^{- j {φ}_{1}} \\ {e}^{- j {φ}_{1}} & 0\end{matrix} ) \qquad ( 3 )$$

wherein
in first column of the matrix in function (3), when a signal is received at port ‘1’ of the first phase shifter 110A, a full amplitude of the signal is directed to e^{-jφ}^{₁} signal, e^{-jφ}^{₁} is an amplitude of a signal received by a port ‘2’ of the first phase shifter 110A with a phase decrement (i.e. time delay) of φ₁,
in second column of the matrix in function (3), when a signal is received at port ‘2’ of the first phase shifter 110A, a full amplitude of the signal is directed to e^{-jφ}^{₁} signal, e^{-jφ}^{₁} is an amplitude of a signal received by a port ‘1’ of the first phase shifter 110A with a phase decrement (i.e. time delay) of φ₁, and
S₃ refers to output signal provided by the first phase shifter 110A.

A second path 114B connecting the first 180-degree coupler 106A to the second 180-degree coupler 106B comprises a second phase shifter 110B and an attenuator 112. The attenuator 112 is configured to introduce losses in the signals provided from the first 180-degree coupler 106A to the second 180-degree coupler 106B via the second path 114B to enable control on coupling coefficient and phase between the first radiator 102 and the second radiator 104. The losses are deliberately introduced in the antenna device 100A by the use of the attenuator 112. The losses enable control on coupling coefficient and phase between the first radiator 102 and the second radiator 104. The second phase shifter 110B is configured to provide controllable phase shift to output signal provided by the first 180-degree coupler 106A to the second 180-degree coupler 106B via the second path 114B. In an example, the second phase shifter 110B receives, as input signal, the output signal from the attenuator 112 and provides controlled phase shifted output signal to the second 180-degree coupler 106B.

The phase-shifts provided by the first phase shifter 110A and the second phase shifter 110B and attenuation provided by the attenuator 112 can have fixed values for a specific solution implementation, or in some implementation may have variable values.

The output signal provided by the attenuator 112 to the second phase shifter 110B is represented by function (4) that is shown below.

$${S}_{4} = ( \begin{matrix}0 & {ϒ}_{3} \\ {ϒ}_{3} & 0\end{matrix} ) \qquad ( 4 )$$

wherein
in first column of the matrix in function (4), when a signal is received at port ‘1’ of the attenuator 112, an amplitude of the signal is directed to [symbol] ₃ signal, [symbol] ₃ is an amplitude of a signal received by a port ‘2’ of the attenuator 112 with an amplitude reduction of a proportion [symbol] ₃, in second column of the matrix in function (4), when a signal is received at port ‘2’ of the attenuator 112, an amplitude of the signal is directed to [symbol] ₃ signal, [symbol] ₃ is an amplitude of a signal received by a port ‘1’ of the attenuator 112 with an amplitude reduction of a proportion [symbol] ₃, S₄ refers to output signal provided by the attenuator 112 to the second phase shifter 110B. The controlled phase shifted output signal provided by the second phase shifter 110B to the second 180-degree coupler 106B is represented by function (5) that is shown below.

$${S}_{5} = ( \begin{matrix}0 & {e}^{- j {φ}_{2}} \\ {e}^{- j {φ}_{2}} & 0\end{matrix} ) \qquad ( 5 )$$

wherein
in first column of the matrix in function (5), when a signal is received at port ‘1’ of the second phase shifter 110B, a full amplitude of the signal is directed to e^{-jφ}^{₂} signal, e^{-jφ}^{₂} is an amplitude of a signal received by a port ‘2’ of the second phase shifter 110B with a phase decrement (i.e. time delay) of φ₂,
in second column of the matrix in function (5), when a signal is received at port ‘2’ of the second phase shifter 110B, a full amplitude of the signal is directed to e^{-jφ}^{₂} signal, e^{-jφ}^{₂} is an amplitude of a signal received by a port ‘1’ of the second phase shifter 110B with a phase decrement (i.e. time delay) of φ₂,
S₅ refers to output signal provided by the second phase shifter 110B to the second 180-degree coupler 106B.

Beneficially, controllable phase difference provided by the first phase shifter 110A and the second phase shifter 110B allows control on the squint angle between beams i.e. radiations transmitted by the first radiator 102 and the second radiator 104. Specifically, the squint angle is reduced via the controllable phase difference provided by the first phase shifter 110A and the second phase shifter 110B as compared to conventional techniques where phase difference and thereby the squint angle cannot be controlled adequately.

According to an embodiment, a set of parameters comprising a first phase shift of the first phase shifter 110A, a second phase shift of the second phase shifter 110B and an attenuation of the attenuator 112 is determined based on one or more desired features of radiating patterns of the first electromagnetic signal and the second electromagnetic signal. The values of the first phase shift, the second phase shift, and attenuation enables in obtaining one or more desired features of radiating patterns such as a desired value of efficiency of radiating patterns of the antenna device 100A, a desired value of squint between radiating patterns. Adjusting the value of attenuation and the phase-shifts allows to find a balance between the squint and the efficiency of radiating patterns. Different values of attenuation enable control of coupling coefficient and phase between the two radiators. Further, selection of different value of the phase shifts allows control on the squint between radiating patterns.

According to an embodiment, the one or more features of the radiating patterns include a squint of the radiating patterns. The term squint of the radiating patterns herein refers to an angle that radiation pattern is offset from normal of a plane of the antenna device 100A. The term squint may also be referred to as beam squint. The squint of the radiating patterns is preferred to be low to obtain good system performance for the antenna device 100A. The conventional antenna devices have high squint of the radiating patterns and/or very high coupling between input ports. The antenna device 100A of the present disclosure achieves significantly lower squint of the radiating patterns by controlling phase difference provided by the first phase shifter 110A and the second phase shifter 110B.

According to an embodiment, the one or more features of the radiating patterns include a directivity of the radiating patterns. The term directivity herein refers to concentration of radiating patterns in a particular direction (e.g. beamforming in a defined direction). The directivity of the radiating patterns is usually preferred to be high to achieve improved system performance for the antenna device 100A. The conventional antenna devices have low directivity of the radiating patterns. The antenna device 100A of the present disclosure obtains higher directivity by providing feed to the first radiator 102 and the second radiator 104 in a combined form in comparison to conventional antenna devices where such tightly-spaced radiators are independently fed.

According to an embodiment, the one or more features of the radiating patterns include a coupling between the radiating patterns measured at the first and second input ports. The term coupling herein refers to electromagnetic interaction between the first radiator 102 and the second radiator 104. The coupling between the radiating patterns is adjusted based on feed provided by the first input port 108A and the second input port 108B.

FIG. 1B is a perspective view of an antenna device with a joint feeding network, in accordance with another embodiment of the present disclosure. With reference to FIG. 1B, there is shown the antenna device 100B. The antenna device 100B includes the first radiator 102 and the second radiator 104. There is further shown the joint feeding network 116.

The joint feeding network 116 is configured to provide joint feed to the first radiator 102 and the second radiator 104. The joint feeding network enables the antenna device 100B to have improved system performance such as improved directivity and controlled beam squint of the electromagnetic radiation transmitted by the first radiator 102 and the second radiator 104. The joint feeding network 116 may also be referred to as a lossy network as the attenuator 112 (of FIG. 1A) is used in the joint feeding network 116, which therefore introduces losses to enable control on coupling coefficient and phase between the first radiator 102 and the second radiator 104.

An amplification factor determines maximum directivity of the two radiators, as higher the value (closer to 1) of amplification factor, the more evenly the two radiators are illuminated. Moreover, a higher value of amplification factor indicates a higher coupling between the two radiators, as the phase centers of two radiating patterns of the two radiators would tend to become coincident. Once amplification factor is set in order to reach a target value of directivity, a net efficiency of the antenna device 100B is only affected by the phase difference between the two radiators of the antenna device 100B.

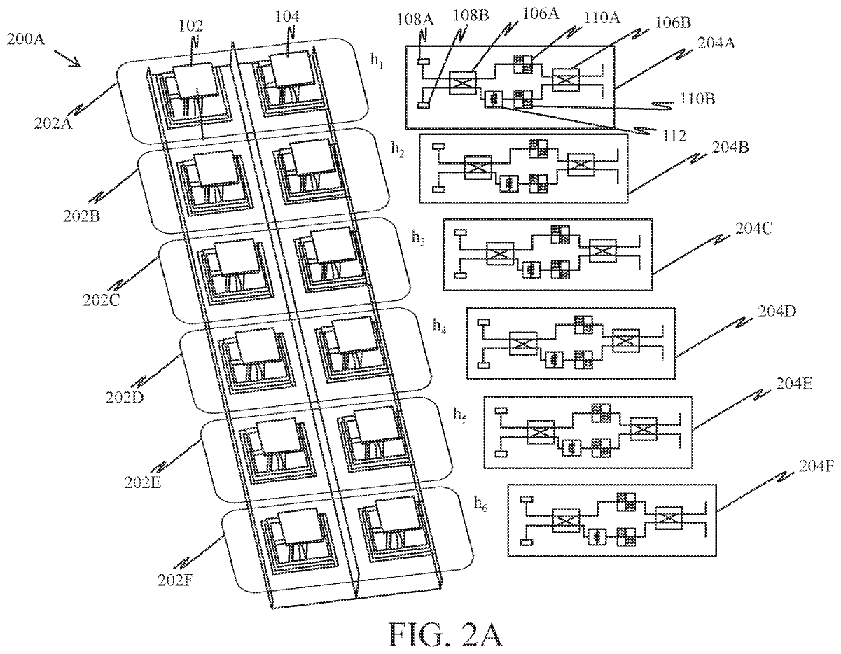

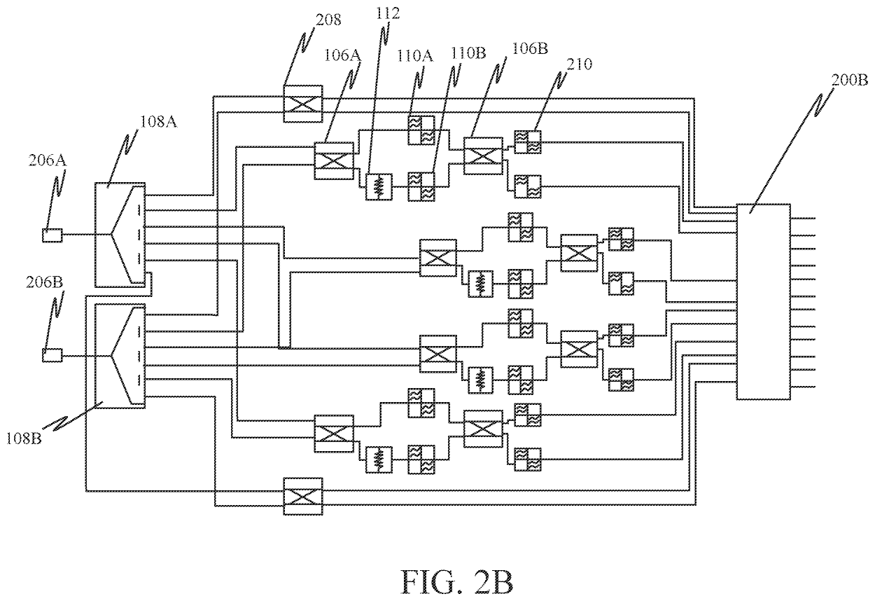

FIG. 2A is an illustration of an array of antenna devices, in accordance with an embodiment of the present disclosure. FIG. 2 is described in conjunction with elements from FIGS. 1A and 1B. With reference to FIG. 2A, there is shown an array 200A of antenna devices. The array 200A of antenna devices includes two or more antenna devices, such as antenna devices 202A to 202F, where each antenna device has a joint feeding network, such as a joint feeding network 204A. In this embodiment, each antenna device of the array 200A of the antenna devices includes two radiators. For example, the first antenna device 202A includes the first radiator 102 and the second radiator 104 jointly fed by the joint feeding network 204A. As shown, the joint feeding network 204A includes the first 180-degree coupler 106A and the second 180-degree coupler 106B, the first input port 108A, the second input port 108B, the first phase shifter 110A, the second phase shifter 110B and the attenuator 112.

The array 200A of antenna devices includes multiple antenna devices similar to the antenna device 102A of FIG. 1A and the antenna device 102B of FIG. 1B. The array 200A of antenna devices includes a corresponding joint feeding network for each of the antenna device in the array 200A of antenna devices.

In an example, the array 200A of antenna devices includes a first antenna device 202A having a first joint feeding network 204A, a second antenna device 202B having a second joint feeding network 204B, a third antenna device 202C having a third joint feeding network 204C and so on till sixth antenna device. In such an example, the first antenna device has a first value of efficiency, the second antenna device has a second value of efficiency, the third antenna device has a third value of efficiency and so on. Thus, the array 200A of antenna devices has a net efficiency represented by the function (6) given below.

$$η = \frac{1}{6} {\sum }_{k = 1}^{6} {η}_{k} \qquad ( 6 )$$

wherein,
η refers to net efficiency of the array 200A of antenna devices,
ηₖ refers to efficiency of an antenna device (such as the first antenna device 202A) such that η₁ is the first efficiency of the first antenna device 202A, η₂ is the second efficiency of the second antenna device 202B, η₃ is the third efficiency of the third antenna device 202C and so on till η₆ which is the sixth efficiency of the sixth antenna device 202F.

Beneficially, combining networks with different efficiencies by the array 200A of antenna devices, a balanced trade-off between directivity, beam squint and antenna efficiency can be achieved. In an example, the 200A array of antenna devices has improved directivity and controlled beam squint of the electromagnetic radiation transmitted by the radiators of each of the antenna devices 202A to 202F.

FIG. 2B is an illustration of an array of antenna devices, in accordance with another embodiment of the present disclosure. FIG. 2B is described in conjunction with elements from FIGS. 1A, 1B, and 2A. With reference to FIG. 2B, there is shown an array 200B of antenna devices. The array 200B of antenna devices includes two or more antenna devices. The array 200B of antenna devices includes a first power combiner 206A and a second power combiner 206B. The array 200B of antenna devices includes an additional 180-degree coupler 208 and an additional phase shifter 210. There is further shown, the first 180-degree coupler 106A and the second 180-degree coupler 106B, the first input port 108A, the second input port 108B, the first phase shifter 110A, the second phase shifter 110B and the attenuator 112.

The array 200B of antenna devices includes the first power combiner 206A and the second power combiner 206B which are connected to the first input port 108A and the second input port 108B. The additional 180-degree coupler 208 provides enhanced isolation and additional phase shifter 210 provides enhanced controlling of squint of radiating patterns among different antenna devices arranged in the array 200B.

According to an embodiment, the first phase shifter 110A, the second phase shifter 110B and the attenuator 112 of each antenna device are configured based on a collective radiating pattern and a collective attenuation loss of the array. The collective radiating pattern herein refers to a combined radiating pattern of the first electromagnetic signal radiated by a first radiator and a second radiator of an antenna device of the array 200B of antenna devices. The collective attenuation loss herein refers to a combined loss of the array based on attenuation generated by the attenuator 112. The first phase shifter 110A and the second phase shifter 110B enable in controlling squint of the collective radiating pattern and the attenuator 112 enables in controlling a coupling coefficient between the first radiator and the second radiator.

According to an embodiment, the array 200B of antenna devices comprises a first power combiner 206A arranged to provide the first input signal to each of the first input ports 108A, and a second power combiner 206B arranged to provide the second input signal to each of the second input ports 108B. Each of the first power combiner 206A and the second power combiner 206B is potentially configured to provide input signals (feeds) for one respective independent radiation pattern via the first input port 108A and the second input port 108B. Moreover, each of the first power combiner 206A and the second power combiner 206B is configured to combine multiple phase shifted signals. In an example, each of the first power combiner 206A and the second power combiner 206B may further pass analog signals to one or more mixers, one or more amplifiers, and one or more analog-to-digital converters.

Beneficially, the array 200B of antenna devices has higher directivity and lower squint for a first radiator and a second radiator (which are tightly-spaced) of each antenna device of the array 200B of antenna devices.

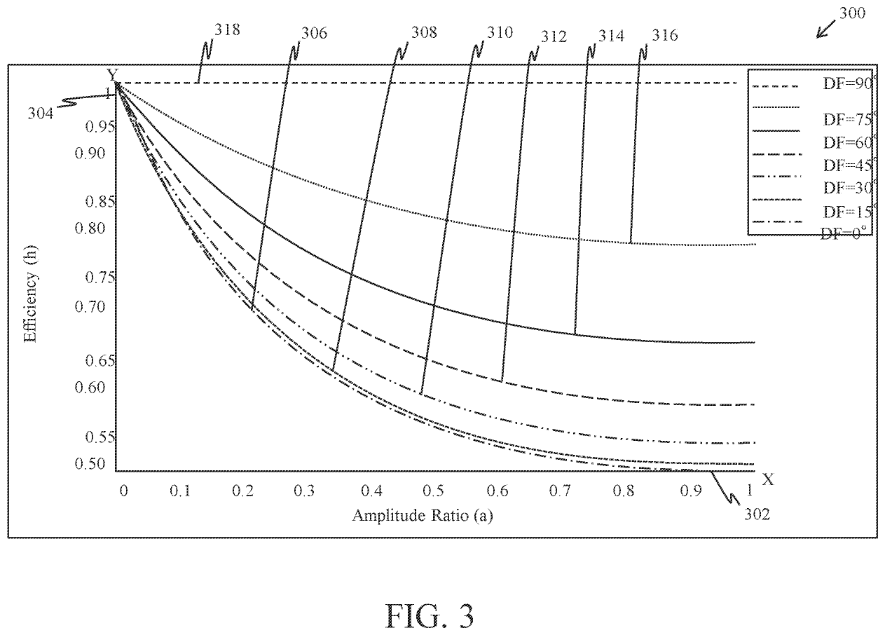

FIG. 3 is a graphical representation that depicts a network efficiency of an antenna device, in accordance with an embodiment of the present disclosure. With reference to FIG. 3, there is shown a graphical representation 300 of the network efficiency of the antenna device in terms of amplitude ratio and phase difference between two radiators of the antenna device.

The graphical representation 300 represents amplitude ratio (in degrees) on X-axis 302 and values of efficiency on Y-axis 304 with respect to different phase differences between the two radiators of the antenna device. An efficiency curve 306 represent different values of efficiency with respect to different amplification factor with phase difference of 0 degrees. An efficiency curve 308 represent different values of efficiency with respect to different amplification factor with phase difference of 15 degrees. An efficiency curve 310 represent different values of efficiency with respect to different amplification factor with phase difference of 30 degrees. An efficiency curve 312 represent different values of efficiency with respect to different amplification factor with phase difference of 45 degrees. An efficiency curve 314 represent different values of efficiency with respect to different amplification factor with phase difference of 60 degrees. An efficiency curve 316 represent different values of efficiency with respect to different amplification factor with phase difference of 75 degrees. An efficiency curve 318 represent different values of efficiency with respect to different amplification factor with phase difference of 90 degrees.

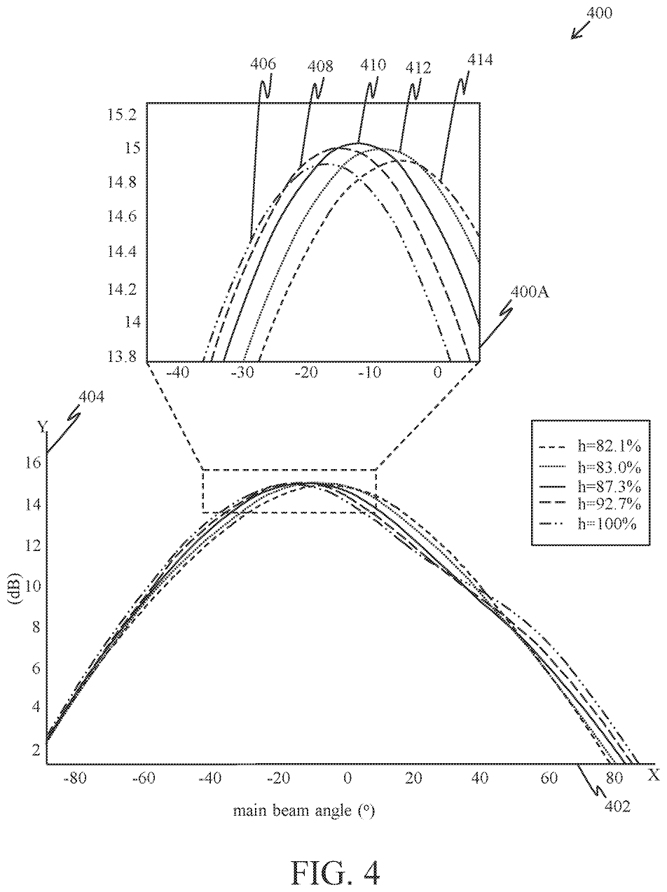

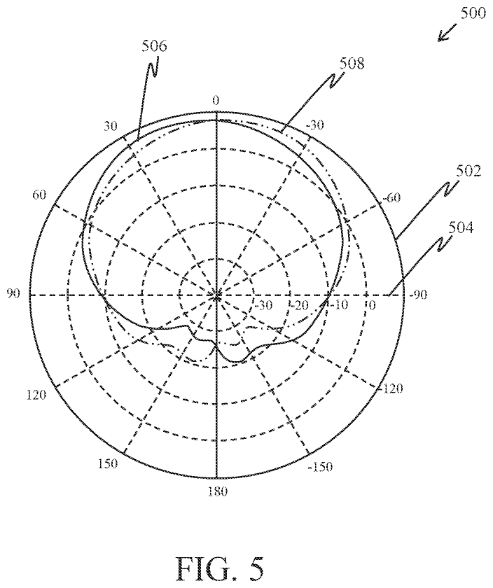

FIG. 4 is a graphical representation that depicts a radiation pattern of an antenna device, in accordance with an embodiment of the present disclosure. With reference to FIG. 4, there is shown a graphical representation 400 of the radiation pattern of the antenna device in terms of squint angle and net efficiency of the antenna device. There is shown an enlarged view 400A of a section of the graphical representation 400.

The graphical representation 400 represents value of squint angle on X-axis 402 and radiation pattern (in Decibels) on Y-axis 404 with respect to different net efficiency of the antenna device. A radiation pattern curve 406 represent different values of radiation patterns with respect to different squint angles when net efficiency of antenna device is 100 percent. A radiation pattern curve 408 represent different values of radiation patterns with respect to different squint angles when net efficiency of antenna device is 92.7 percent. A radiation pattern curve 410 represent different values of radiation patterns with respect to different squint angles when net efficiency of antenna device is 87.3 percent. A radiation pattern curve 412 represent different values of radiation patterns with respect to different squint angles when net efficiency of antenna device is 83 percent. A radiation pattern curve 414 represent different values of radiation patterns with respect to different squint angles when net efficiency of antenna device is 82.1 percent.

A phase difference between two radiators of the antenna device participates in the squint angle of the radiation pattern radiated by the antenna device. The net efficiency of the antenna device pairs with the phase difference between the two radiators. As seen in the graphical representation 400, antenna device with lower efficiency (i.e. lower phase difference) represented by for example radiation pattern curve 414, have lower squint angle.

FIG. 5 is a graphical representation that depicts a radiation pattern in a main plane of an antenna device operation, in accordance with an embodiment of the present disclosure.

With reference to FIG. 5, there is shown a graphical representation 500 of the radiation pattern of the antenna device in terms of a phase shifts and gains.

The graphical representation 500 represents angles on circular-axis 502 and value of gains on horizontal-axis 504. A radiation pattern curve 506 represent how the radiated signal, corresponding to one of the input ports, is distributed over the angular region. A radiation pattern curve 508 represent how the radiated signal, corresponding to the other input port, is distributed over the angular region. The two radiation pattern curves (cut of a main plane of the device function), show how one radiation pattern curve 506 squints to the left, corresponding to one input port; and the other radiation pattern curve 508 squints to the right, corresponding to the other input port.

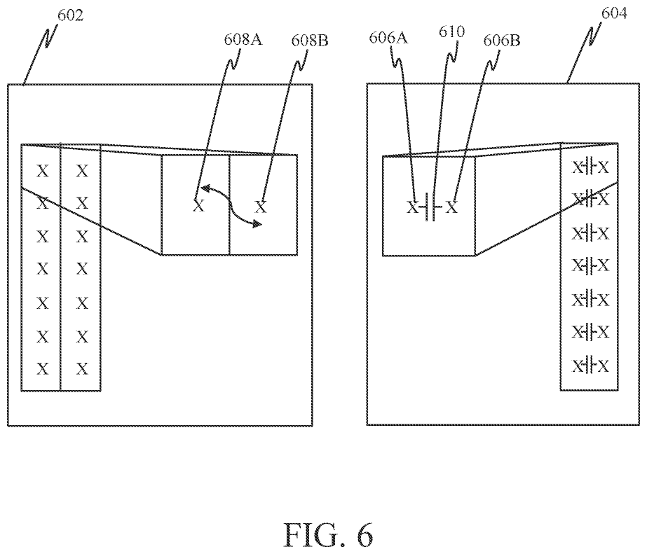

FIG. 6 is an illustration of an array of antenna devices in comparison to a conventional array of antenna devices, in accordance with an embodiment of the present disclosure. With reference to FIG. 6, there is shown an array of antenna device 602 used in the present disclosure and an array of antenna device 604 used conventionally. The array of antenna device 602 used in the present disclosure includes a first radiator 606A and a second radiator 606B. The array of antenna device 604 used conventionally includes a conventional first radiator 608A and a conventional second radiator 608B.

In the array of antenna devices 604 used conventionally, coupling between the conventional first radiator 608A and the conventional second radiator 608B, degrades system performance of the antenna device 604 as the conventional first radiator 608A and the conventional second radiator 608B are designed to work independently in the array of antenna device 604.

In the array of antenna devices 602 used in the present disclosure, the first radiator 606A and the second radiator 606B are designed to cooperate and radiate together via a joint feeding network 610. As a result, coupling is controlled and system performance is significantly improved in comparison to conventional antenna systems, such as the array of antenna device 604 used conventionally.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. An antenna device, comprising:
a first radiator, the first radiator configured to radiate a first electromagnetic signal;
a second radiator, the second radiator configured to radiate a second electromagnetic signal; and
a joint feeding network comprising a first 180-degree coupler and a second 180-degree coupler arranged in sequence;
wherein the first 180-degree coupler is configured to receive a first input signal through a first input port and a second input signal through a second input port;
wherein the second 180-degree coupler is configured to provide a first output signal to the first radiator and a second output signal to the second radiator;
wherein a first path connecting the first 180-degree coupler to the second 180-degree coupler comprises a first phase shifter; and
wherein a second path connecting the first 180-degree coupler to the second 180-degree coupler comprises a second phase shifter and an attenuator.

2. The antenna device of claim 1, wherein a set of parameters comprising a first phase shift of the first phase shifter, a second phase shift of the second phase shifter, and an attenuation of the attenuator is determined based on one or more desired features of radiating patterns of the first electromagnetic signal and the second electromagnetic signal.

3. The antenna device of claim 2, wherein the one or more features of the radiating patterns include a squint of the radiating patterns.

4. The antenna device of claim 2, wherein the one or more features of the radiating patterns include a directivity of the radiating patterns.

5. The antenna device of claim 2, wherein the one or more features of the radiating patterns include a coupling between the radiating patterns measured at the first and second input ports.

6. The antenna device of claim 1, wherein the joint feeding network is configured such that the first electromagnetic signal and the second electromagnetic signal combine to form a first radiating pattern corresponding to the first input signal and a second radiating pattern corresponding to the second input signal.

7. The antenna device of claim 1, wherein the first radiator and the second radiator are configured to operate in a frequency band.

8. The antenna device of claim 7, wherein the frequency band corresponds to a wavelength, and wherein a distance between the first radiator and the second radiator is less than the wavelength.

9. An array of antenna devices, comprising two or more antenna devices, wherein each antenna device comprises:
a first radiator, the first radiator configured to radiate a first electromagnetic signal;
a second radiator, the second radiator configured to radiate a second electromagnetic signal; and
a joint feeding network comprising a first 180-degree coupler and a second 180-degree coupler arranged in sequence;
wherein the first 180-degree coupler is configured to receive a first input signal through a first input port and a second input signal through a second input port;
wherein the second 180-degree coupler is configured to provide a first output signal to the first radiator and a second output signal to the second radiator;
wherein a first path connecting the first 180-degree coupler to the second 180-degree coupler comprises a first phase shifter; and
wherein a second path connecting the first 180-degree coupler to the second 180-degree coupler comprises a second phase shifter and an attenuator.

10. The array of claim 9, wherein the first phase shifter, the second phase shifter, and the attenuator of each antenna device are configured based on a collective radiating pattern and a collective attenuation loss of the array.

11. The array of claim 10, further comprising a first power combiner arranged to provide the first input signal to each of the first input ports, and a second power combiner arranged to provide the second input signal to each of the second input ports.

12. The array of claim 9, wherein a set of parameters comprising a first phase shift of the first phase shifter, a second phase shift of the second phase shifter, and an attenuation of the attenuator is determined based on one or more desired features of radiating patterns of the first electromagnetic signal and the second electromagnetic signal.

13. The array of claim 12, wherein the one or more features of the radiating patterns include a squint of the radiating patterns.

14. The array of claim 12, wherein the one or more features of the radiating patterns include a directivity of the radiating patterns.

15. The array of claim 12, wherein the one or more features of the radiating patterns include a coupling between the radiating patterns measured at the first and second input ports.

16. The array of claim 9, wherein the joint feeding network is configured such that the first electromagnetic signal and the second electromagnetic signal combine to form a first radiating pattern corresponding to the first input signal and a second radiating pattern corresponding to the second input signal.

17. The array of claim 9, wherein the first radiator and the second radiator are configured to operate in a frequency band.

18. The array of claim 17, wherein the frequency band corresponds to a wavelength, and wherein a distance between the first radiator and the second radiator is less than the wavelength.

19. A wireless communication system, wherein the system comprises an antenna device comprising:
a first radiator, the first radiator configured to radiate a first electromagnetic signal;
a second radiator, the second radiator configured to radiate a second electromagnetic signal; and
a joint feeding network comprising a first 180-degree coupler and a second 180-degree coupler arranged in sequence;
wherein the first 180-degree coupler is configured to receive a first input signal through a first input port and a second input signal through a second input port;
wherein the second 180-degree coupler is configured to provide a first output signal to the first radiator and a second output signal to the second radiator;
wherein a first path connecting the first 180-degree coupler to the second 180-degree coupler comprises a first phase shifter; and
wherein a second path connecting the first 180-degree coupler to the second 180-degree coupler comprises a second phase shifter and an attenuator.

20. The system of claim 19, wherein a set of parameters comprising a first phase shift of the first phase shifter, a second phase shift of the second phase shifter, and an attenuation of the attenuator is determined based on one or more desired features of radiating patterns of the first electromagnetic signal and the second electromagnetic signal.
